(19) United States
(12) Patent Application Publication
(10) Pub. No.: US 2020/0102934 A1
(43) Pub. Date: Apr. 2, 2020

(54) METHOD FOR OPERATING A WIND TURBINE AND DEVICE FOR THE OPEN-LOOP AND/OR CLOSED-LOOP CONTROL OF A WIND TURBINE AND CORRESPONDING WIND TURBINE HAVING A ROTOR AND A GENERATOR DRIVEN BY THE ROTOR FOR GENERATING ELECTRICAL POWER

(71) Applicant: Wobben Properties GmbH, Aurich (DE)

(72) Inventors: Ralf MESSING, Aurich (DE); Christian Frank NAPIERALA, Aurich (DE); Christoph SCHEIT, Aurich (DE); Dimitrios BEKIROPOULOS, Aurich (DE)

(21) Appl. No.: 16/469,997

(22) PCT Filed: Dec. 14, 2017
(86) PCT No.: PCT/EP2017/082869

§ 371 Date: Jun. 14, 2019

(30) Foreign Application Priority Data
Dec. 16, 2016 (DE) 10 2016 124 703.0

(51) Int. Cl. F03D 7/02; F03D 9/25

(52) U.S. Cl. CPC F03D 7/0276; F03D 7/0224; F03D 9/257

(57) ABSTRACT

A method for operating a wind power installation having a rotor and a generator driven via the rotor for generating electrical power, in which provides for an adapted rotational speed of the rotor of the wind power installation for generating electrical power to be output to be specified using the adapted operational management and therefore using the air density relevant to the wind power installation, wherein, for generating optimized electrical power to be output, the adapted rotational speed is an increased rotational speed for a reduced air density or a reduced rotational speed for an increased air density, wherein additionally or alternatively a sound emission of the wind power installation is determined for the specified adapted rotational speed of the rotor using the air density relevant to the wind power installation, and the adapted rotational speed is corrected, in particular on the basis of the determined sound emission, using the air density relevant to the wind power installation.

### BACKGROUND

### Technical Field

The invention relates to a method for operating a wind power installation having a rotor and a generator driven via the rotor for generating an electrical power.

### Description of the Related Art

Operational management is adapted on the basis of the air density relevant to the wind power installation. Such a method is already known by the applicant from EP 1 368 566 B1.

In addition, it is fundamentally known practice to take into account the air density relevant to a wind power installation when operating a wind power installation in order to also take into account a mass flow density at the rotor blade.

In the case of a wind power installation having a rotor which can be driven by the wind and has adjustable rotor blades, DE 19 844 258 A1 provides for a generator connected to the rotor to be used to generate electrical energy, wherein the generator can output power at a variable rotor rotational speed. The operational management system provides for the rotor rotational speed to be designed to be controlling within a specified wind speed range by adjusting the rotor blade angles.

According to the article in the National Academy Press, 1991, “Assessment of Research Needs for Wind Turbine Rotor Materials Technology—Chapter 6 Active Control in Wind Turbines—Control Problem for Wind Turbines”—pages 91 to 108 (http://www.nap.edu/read/1824/chapter/8#96)—in particular page 96—provision is made for the mass flow density and pressure to be measured at the rotor blade in order to counter upcoming turbulence with appropriate open-loop control within the scope of relatively rapid adaptation of the blade structure.

JP 2008/309488 A provides an open-loop controller which adapts the rotational speed of the electrical generator on the basis of the wind power density, the wind energy and the integrated wind energy of the wind in order to enable a balanced power output—in this case, the air density is also concomitantly taken into account when considering the wind energy density. This is also similarly taken into account in EP 2 264 313 B1, wherein a mass flow sensor like in JP 2008/309488 is used.

In the priority application for the present PCT application, the German Patent and Trademark Office researched the following prior art: WO 2012/149984 A1 and WO 2014/078773 A1.

Power calculations for a wind power installation are currently carried out assuming the standard atmosphere. The standard density ρ_norm used in this case for the air density ρ_Luft is ρ_norm=1.225 kg/m³, that is to say according to the rules of the International Civil Aviation Organization (ICAO) for an international standard atmosphere (ISA). A wind power installation is therefore designed according to a predetermined temperature envelope according to the IEC (International Engineering Code). EP 1 918 581 A2 provides, for example, for an air density to be determined in cold weather conditions by measuring the temperature and the pressure of the environment—this can be used to reduce the load acting on a wind power installation.

However, at sites of high altitude and/or with temperatures which are increased on average, these assumptions are no longer correct, at least quantitatively. At sites of high altitude, quite serious deviations in the density toward smaller values of up to approximately 20% of the design conditions based on the standard density ρ_norm used may arise—the normal procedure should therefore also be fundamentally questioned in such cases of serious deviations.

The following applies to the wind power:

$$p = \frac{ρ}{2} {v}_{∞}^{3} {Ac}_{p} η = \frac{ρ}{2} \frac{{v}_{tip}^{3}}{{λ}^{3}} {Ac}_{p} η$$

In this case, A represents the area through which there is a flow, η represents the generator efficiency and cₚ represents the coefficient of power. The coefficient of power is assumed to be constant below. If the power P and the other variables of the equation are kept constant, the following follows for the blade tip speed

$${v}_{tip} = \sqrt[3]{\frac{2 P {λ}^{3}}{ρ {Ac}_{p} η}} ∼ \sqrt[3]{\frac{1}{ρ}}$$

The blade tip speed vₜᵢₚ is then inversely proportional to the third root of the density ρ and the power is directly proportional to the density ρ if other variables are constant.

This has already been specifically identified by the applicant in EP 1 368 566 cited at the outset. Unlike the prior art, said document explicitly provides for a power characteristic curve to be stored in the open-loop control apparatus of a wind power installation, which power characteristic curve allows the open-loop controller of the wind power installation to determine the associated generator power from the determined rotor rotational speed which depends on the wind speed. It has been identified that, if the amount of energy in the wind is too low, the rotor of the generator cannot apply a created generator torque and the rotor rotational speed can therefore fall on account of an excessively high generator torque. As a solution, EP 1 368 566 B1 proposes that the consideration of the altitude of the installation location of the wind power installation above sea level takes into account the lower air density in the power characteristic curve. As a result, the power associated with a rotor rotational speed and therefore a determined tip speed ratio and to be generated by the wind power installation can be accordingly adapted, that is to say reduced, with the result that the generator torque, as a result of the excitation current set by the open-loop control apparatus, does not exceed the torque provided via the rotor. This results in the efficiency stipulated via the power characteristic curve being retained and the maximum energy being able to be taken from the wind.

Whereas this may be fundamentally advantageous, it has nevertheless likewise proved relevant to optimize the annual energy production (AEP) of a wind power installation. This applies, in particular, to the above-mentioned case of a lower air density, on account of which the available wind power is lower—it is desirable to compensate for such a lower available wind power, in particular without disadvantageous effects for the wind power installation and the environment.

### BRIEF SUMMARY

Provided are a method and a device for operating a wind power installation having a rotor and a generator driven via the rotor for generating an electrical power, as well as a corresponding wind power installation. Provided are ways is to compensate for the consequently lower available wind power, in particular in a reliable and/or improved manner, taking into account an air density relevant to the wind power installation.

In the method, an environmental variable relevant to the wind power installation and comprising at least an air density relevant to the wind power installation and also a rotational speed of the generator rotor (rotor) are determined and an electrical power to be output by the generator is specified. In the method, the wind power installation for generating the power to be output is adjusted according to operational management. The generator is preferably adjusted by means of an excitation current of the generator. The operational management indicates a relationship between the rotational speed of the rotor and the electrical power to be output.

In particular, in the case of such a method or a corresponding device for open-loop and/or closed-loop control or a corresponding wind power installation, provided is a method to adapt the operational management on the basis of the lower—in comparison with normal conditions—air density relevant to the wind power installation in such a manner that an electrical power to be output by the generator can be optimized, in particular improved.

This should preferably be understood in the sense of an increased AEP (Annual Energy Production) of a wind power installation, in which case effects on the environment and/or excessive loads on the wind power installation should preferably be nevertheless kept below. In particular, provided is a way to specify a corresponding device for the open-loop and/or closed-loop control of a wind power installation and to specify a corresponding wind power installation which takes this problem into account.

A method provides for:
an adapted rotational speed of the rotor of the wind power installation for generating an electrical power to be output to be specified using the adapted operational management and therefore using the air density relevant to the wind power installation, wherein, for generating an optimized electrical power to be output, the adapted rotational speed is an increased rotational speed for a reduced air density.

As an alternative or in addition to this first variant, according to a second variant according to the invention,
a sound emission of the wind power installation is also preferably determined for the specified rotational speed or adapted rotational speed of the rotor using the air density relevant to the wind power installation, and
the specified rotational speed (in the case of the alternative) or the adapted rotational speed (in the case of the additional measure) is also preferably corrected.

The specified rotational speed (in the case of the alternative) or the increased rotational speed (in the case of the additional measure) is preferably limited. The correction is preferably carried out on the basis of the determined sound emission using the air density relevant to the wind power installation.

Regarding the first variant, the invention is based on the consideration that the operational management can be adapted on the basis of the air density relevant to the wind power installation. This should result in the adapted rotational speed of the rotor being selected for the purpose of generating a preferably optimized electrical power to be output by the generator. In the case of a comparatively reduced air density relevant to the wind power installation, this means that the adapted rotational speed is increased in comparison with a (nominal) rotational speed relating to a standard density of a standard atmosphere.

Regarding the second variant, the invention has also identified that, for a rotational speed of the rotor or with the measure of an adapted rotational speed of the rotor of the wind power installation, a sound emission of the wind power installation is also influenced for the specified rotational speed or adapted rotational speed of the rotor. The invention alternatively or additionally provides for a sound emission of the wind power installation to be determined for the specified or adapted rotational speed of the rotor using the air density relevant to the wind power installation and for the specified or adapted rotational speed to be corrected on the basis of the sound emission determined using the air density relevant to the wind power installation.

In other words, regarding the second variant, for example, the operational management according to the invention allows the sound pressure caused by the rotor of the wind power installation and therefore the sound emission of the rotor or the substantially relevant sound emission of the wind power installation to be lower than under standard conditions of a standard atmosphere for the same installation power, adapted rotational speed and lower air density—that is to say in the case of electrical power to be output which is optimized in this respect.

The concept according to the invention is explained more specifically below using an example: for the same installation power—that is to say as identified by the invention according to the first variant—there is a possibly increased inflow speed for a reduced air density, with the result that—as identified by the invention—the rotational speeds in the operating characteristic curve and/or the desired rotational speed can be adapted in order to keep the tip speed ratio constant using the rotational speed. As explained in detail in the detailed description, this may make it possible to adapt the rotational speed, for example, as follows:

$${n}_{korr} = \sqrt[3]{\frac{{ρ}_{norm}}{ρ}} n \qquad ( I )$$

In this case, ρₙₒᵣₘ is the standard density or the density “standardized” according to the ISA, for which the operating characteristic curve was originally designed, for example normally according to the IEC, and nₖₒᵣᵣ is the adapted rotational speed in comparison with the rotational speed n originally defined in the operating characteristic curve. In order to generate an optimized electrical power to be output, the adapted rotational speed according to the concept of the first variant according to the invention is an increased rotational speed for a reduced air density.

Additionally or alternatively, it is also possible according to the second variant to correct the rotational speed in such a manner that the sound pressure caused by the wind power installation remains constant to the greatest possible extent. It follows from this that the rotational speed can change according to the density for the same sound pressure; for example with a dependence as follows:

$${n}_{korr} = {( \frac{{ρ}_{norm}}{ρ} )}^{\frac{2}{5}} n \qquad ( II )$$

Therefore, even a rotational speed which is increased yet further in comparison with the specified rotational speed or adapted rotational speed—that is to say possibly also an increased rotational speed for a lower air density according to the first variant—could be used as the corrected rotational speed in comparison with the above rotational speed adapted according to equation (I) without increasing the sound emission of the rotor.

Overall, the invention has therefore identified that the consideration of the sound pressure for a sound emission of the wind power installation for the purpose of specifying an adapted rotational speed of the rotor using an air density relevant to the wind power installation should be included as an important or further important corrective parameter which can be used to adapt the rotational speed (for example according to equation (II)) or to further correct (for example according to equation (II)) the adapted rotational speed (for example according to equation (I)). These measures of the second variant are advantageously likewise carried out using the air density relevant to the wind power installation for the purpose of determining the relevant sound emission.

If necessary, this may either result in a further increase in the rotational speed in the sense of a correction in the manner described above. However, it may also possibly result in a limitation, in particular an upper limitation of the adapted rotational speed—the latter alternative makes it possible to provide a particular specified sound emission.

In order to optimize, in particular, the electrical power to be output by the wind power installation—in brief and simple terms, preferably “power optimization under the boundary condition of a sound emission limit”—the concept according to the invention proves to be improved in comparison with conventional power optimization, but in any case as power optimization which is harmless overall for the environment, since the sound emission of the wind power installation remains within limits even for a specified adapted rotational speed of the rotor.

As a result, within the scope of a first variant, the concept of the invention advantageously makes it possible for the first time to comply with the annual energy production in wind power installations at sites with a lower density by using changed operational management, preferably by means of a changed operating characteristic curve. In order to compensate for the lower available wind power, the concept of the invention provides, in particular, for the installations to be operated at a higher nominal rotational speed.

Since this can also result in a higher or maximum blade tip speed—as identified by the invention in a second variant—an increased sound pressure can be expected from the rotor. On the other hand—as likewise identified by the invention—the density and temperature likewise have an effect on the sound pressure. The invention has identified for the first time the serious effect of the environmental parameters of density and speed of sound on the rotor blade acoustics and therefore the relevant sound emission of the wind power installation.

It becomes apparent that a density reduced by approximately 20%, for example, results in a sound pressure of the rotor which is lower by approximately 2 dB. A theoretical comparison of the level expected on account of the higher rotational speed with the reduction on account of the lower density shows that, for the same power, a lower density and an increased rotational speed, the wind power installation could either tend to become quieter, that is to say it has a lower sound emission, or else the rotational speed could be increased further. This would increase the efficiency of the generator.

Advantageous developments of the invention can be gathered from the subclaims and specifically specify advantageous possibilities for implementing the concept explained above within the scope of the problem and with regard to further advantages.

The adaptation can be carried out, for example, for a desired rotational speed on the basis of at least one variable which is determined directly by means of metrology and describes the sound emission. The at least one variable describing sound emission may be, for example, the sound pressure and/or the sound pressure level and/or the sound power level and/or the sound frequency and/or a sound pressure adapted to a hearing sensation, in particular frequency-assessed sound pressure, in particular of the rotor or the wind power installation.

If the air density, as a relevant environmental variable, is an air density which is reduced in comparison with a standard density of a standard atmosphere, one development advantageously provides for the operational management to be adapted on the basis of the reduced air density for the wind power installation. As explained above, this is the case, in particular, in wind power installations at sites with a lower density, as occurs in wind power installations at high altitudes, for example.

Within the scope of a preferred first variant as a development, provision is made (for example taking into account (I) and then taking into account (II)) for
the corrected rotational speed to be increased yet further in comparison with the adapted rotational speed on the basis of the sound emission determined using the air density relevant to the wind power installation, or
the corrected rotational speed to not be increased yet further in comparison with the adapted rotational speed, and the wind power installation to be operated with a sound emission which is still lower or remains the same. As explained above, this development is carried out on the basis of the knowledge that even the sound emissions of the rotor, and therefore substantially of the wind power installation, which can be fundamentally expected for an increased rotational speed, are rather such that they allow a further increase in the rotational speed.

Within the scope of a preferred second variant as a development, the practice of alternatively carrying out a corrected and adapted rotational speed which is carried out on the basis of the sound emissions determined using the air density relevant to the wind power installation is also within the scope of the concept of the invention (for example only taking into account (II)). This stipulation is generally possible insofar as the operational management of the wind power installation is oriented only to the sound emission.

Within the scope of this second variant as a development, provided is a method comprising the following steps:
a sound emission of the wind power installation is determined for the specified adapted rotational speed of the rotor using the air density relevant to the wind power installation, and
the rotational speed is corrected on the basis of the sound emission determined using the air density relevant to the wind power installation.

However, this is advantageously also carried out under the verified assumption, if possible, that the power to be output is ensured according to operational management which indicates a relationship between the rotational speed of the rotor and the electrical power to be output.

Furthermore, for both variants, provision may advantageously be made for
the operational management to comprise a rotational speed/power operating characteristic curve (n/P operating characteristic curve), wherein
an adapted operating characteristic curve is specified on the basis of the air density relevant to the wind power installation, and the wind power installation for generating the power to be output is adjusted by means of the adapted n/P operating characteristic curve in the operational management, wherein
the specified adapted current rotational speed is specified in the operational management and is then adjusted by means of open-loop control and/or closed-loop control.

The air density may be a current air density at the location of the wind power installation which is continuously measured and then dynamically adapted. Additionally or alternatively, the air density may be a generally prevailing air density at the location of the wind power installation which is measured once or repeatedly and is then statically adapted.

The air density may be determined from measured environmental values. The environmental values may also preferably comprise an air temperature relevant to the wind power installation. The air density may also be determined from further measured environmental values, wherein the further environmental values also optionally comprise air pressure and relative or absolute humidity.

Within the scope of one particularly preferred development, it also becomes apparent that the air temperature can be used as a relevant environmental variable in the sense of the concept of the invention for a particularly preferred development. At sites of high altitude, for example Tchamma, Chile, the density is reduced for the same speed of sound. At other sites, there may be a reduced density on account of increased environmental temperatures. In the latter case, the speed of sound also changes as a function of the temperature

c₀=\sqrt{κRT}

where the isentropic component ϰ and the specific gas constant of air, R, can be considered to be constant. The density likewise changes with the temperature.

It is therefore particularly preferred that a normal sound emission of the wind power installation in a standard atmosphere is determined for the rotational speed of the rotor, and the normal sound emission is compared with the sound emission of the wind power installation for the adapted rotational speed of the rotor using the air density and/or air temperature relevant to the wind power installation, and the adapted rotational speed of the rotor of the wind power installation is corrected and is optionally limited.

In particular, either in addition or as an alternative to a previous density-dependent correction of the rotational speed, the wind power installation can be operated by means of the corrected rotational speed for the corrected sound emission in such a manner that the wind power installation is operated at a corrected sound emission limit. In this respect, reference is made, in particular, to the exemplary embodiment according to FIG. 3 which is cited by way of example in this respect.

Within the scope of one particularly preferred embodiment, a preferred procedure is specifically provided in such a manner that
the rotational speed of the rotor is initially adjusted taking into account a predetermined standard density of a standard atmosphere, and
the adapted rotational speed is then specified taking into account the air density and/or air temperature relevant to the wind power installation, wherein
the adapted rotational speed is then corrected and the installation is operated by means of the corrected rotational speed at the corrected sound emission limit.

Within the scope of the further particularly preferred embodiment which has already been previously mentioned, the concept of the invention has proved to be advantageous if the air density is an air density which is reduced in comparison with a standard density and the corrected rotational speed is a rotational speed which is increased in comparison with the rotational speed for the standard atmosphere. This increased rotational speed may be increased or limited further in comparison with the adapted rotational speed. The concept of the invention has also proved to be advantageous if the air density is an air density which is increased in comparison with a standard density and the corrected rotational speed is a rotational speed which is reduced in comparison with the rotational speed for the standard atmosphere. This reduced rotational speed may be reduced or else limited further in comparison with the adapted rotational speed.

This adaptation of the rotational speed to be carried out first of all and the subsequent correction or limitation of the rotational speed—in the sense of an increase or else reduction—optionally also makes it possible to take into account the dependence of the air temperature.

Within the scope of this development, a rotational speed of the rotor of the wind power installation can thus be increased with open-loop and/or closed-loop control on the basis of the air temperature and/or air density using the reduced air density relevant to the wind power installation. For example, a power can be advantageously increased or a power to be output can be ensured, for instance in accordance with an annual energy production (AEP).

In order to implement this procedure, a correction for adapting the desired rotational speed may therefore be provided in such a manner that it is initially determined whether the air density is below a magnitude relevant to the sound emission, that is to say it is first of all determined, in particular, whether the air density is below the standard density (according to an ISA in accordance with the provisions of the ICAO) and, if so, the desired rotational speed is adapted with regard to the maximum permissible sound emission value.

The wind power installation can be advantageously adjusted overall for generating the power to be output by adjusting the generator, by adjusting an excitation current, preferably of the generator rotor, by adjusting one or more rotor blades and/or one or more flow elements on a rotor blade, by setting an azimuth position of the nacelle of the wind power installation.

It has also proved to be advantageous that the rotational speed is influenced and/or adjusted by controlling a setting angle of a component on the rotor, in particular a pitch angle of a rotor blade, and/or a setting angle and/or one or more flow elements on a rotor blade by specifying the electrical power to be output, the air density and the sound emission, in particular one or more relevant sound pressure levels SPL for a sound pressure S describing the sound emission.

Embodiments of the invention are now described below using the drawing. The drawing is not necessarily intended to represent the embodiments in a manner true to scale, but rather the drawing, where expedient for explanation, is in a schematic and/or slightly distorted form. With regard to additions of the teachings which can be directly discerned from the drawing, reference is made to the relevant prior art. In this case, it should be taken into account that various modifications and changes relating to the form and the detail of an embodiment can be made without departing from the general concept of the invention. The features of the invention which are disclosed in the description, in the drawing and in the claims may be essential to the development of the invention both individually and in any desired combination. In addition, all combinations of at least two of the features disclosed in the description, the drawing and/or the claims fall within the scope of the invention. The general concept of the invention is not restricted to the exact form or the detail of the preferred embodiments described and shown below or restricted to subject matter which would be restricted in comparison with the subject matter claimed in the claims. Where dimensional ranges are indicated, values lying within the stated limits are also intended to be disclosed as limit values, and to be able to be used and claimed in any way. For the sake of simplicity, identical reference signs are used below for identical or similar parts or parts with an identical or similar function.

### BRIEF DESCRIPTION OF THE SEVERAL VIEWS OF THE DRAWINGS

Further advantages, features and details of the invention emerge from the following description of the preferred embodiments and also on the basis of the drawing, in which:

FIG. 1 shows a wind power installation having a tower and a nacelle according to one preferred embodiment;

FIG. 2 shows a wind farm having, by way of example, three wind power installations according to one preferred embodiment;

FIG. 3 shows a standardized rotational speed/density graph with sound pressure level contours (SPL in dB) with respect to a reference sound pressure for explaining one preferred embodiment of the method in which the adapted rotational speed is corrected and the installation is operated by means of the corrected rotational speed at a corrected sound emission limit;

FIG. 4 shows a standardized rotational speed/density graph with contours relating to a relevant sound pressure for a sound emission of a wind power installation—for example taking into account (II) and relating to a power or, for example, taking into account (I) as a boundary condition during operation of a wind power installation—;

FIG. 5A shows a diagram of a closed-loop control circuit for correcting the rotational speed with the optional boundary condition of a sound pressure S and a power P when operating a wind power installation under full load;

FIG. 5B shows a diagram of a closed-loop control circuit for correcting the rotational speed with the optional boundary condition of a sound pressure S and a power P when operating a wind power installation under partial load.

### DETAILED DESCRIPTION

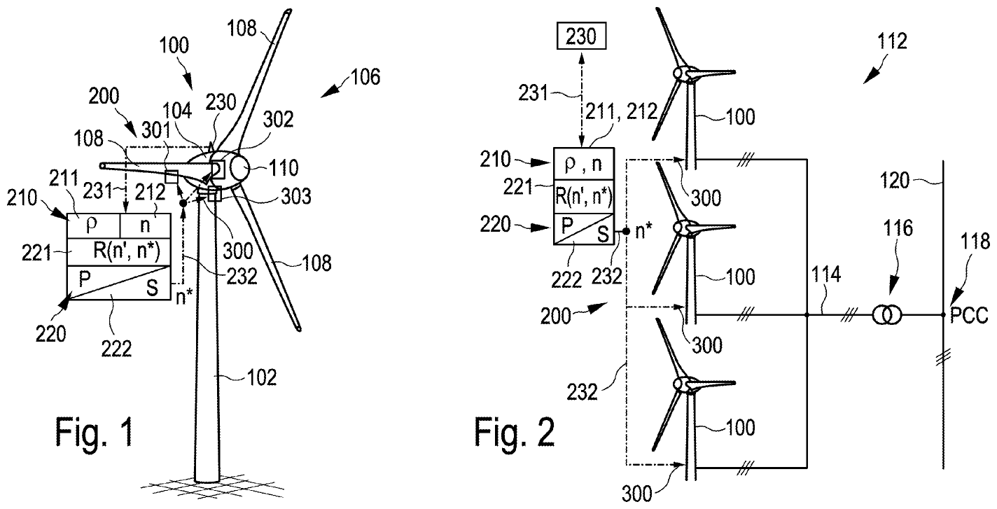

FIG. 1 shows a wind power installation 100 having a tower 102 and a nacelle 104. A rotor 106 having three rotor blades 108 and a spinner 110 is arranged on the nacelle 104. The rotor 106 is caused to rotate by the wind during operation and thereby drives a generator in the nacelle 104.

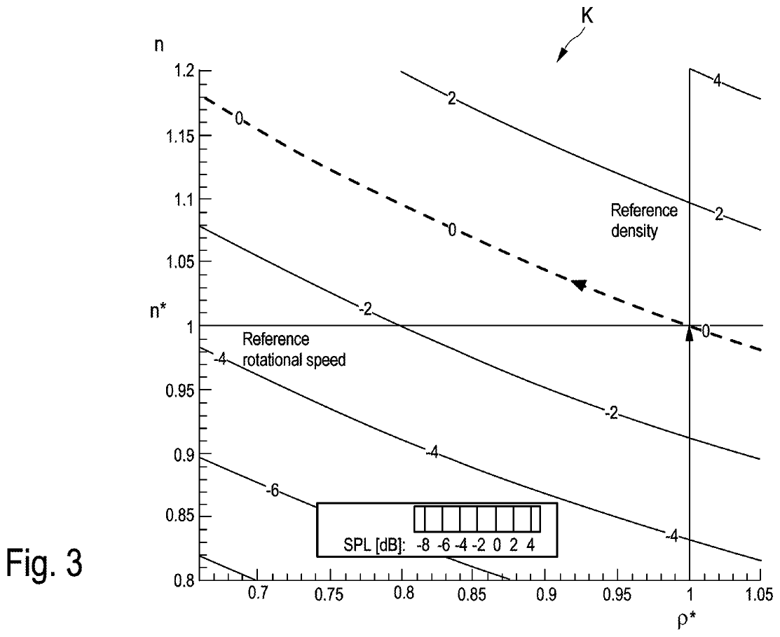

FIG. 2 shows a wind farm 112 having, by way of example, three wind power installations 100 which may be identical or different. The three wind power installations 100 are therefore representative of fundamentally any desired number of wind power installations in a wind farm 112. The wind power installations 100 provide their power, specifically in particular the current generated, via an electrical farm network 114. In this case, the currents or powers respectively generated by the individual wind power installations 100 are added, and a transformer 116 is usually provided, which transformer steps up the voltage in the farm in order to then feed it into the supply network 120 at the feed-in point 118 which is also generally referred to as a PCC (point of common coupling). FIG. 2 is only a simplified illustration of a wind farm 112 with an open-loop controller. The farm network 114 can also be configured differently, for example, by virtue of a transformer also being present at the output of each wind power installation 100, for example, to name just one other exemplary embodiment.

A wind power installation in FIG. 1 or any wind power installation in the wind farm according to FIG. 2 or the wind farm according to FIG. 2 is equipped in the present case with a device 200 for open-loop and/or closed-loop control (open-loop and closed-loop control device 200) as part of operational management with closed-loop controllers 220. These closed-loop controllers 220 control an actuating device 300 having corresponding actuators 301, 302, 303 for rotor blades, the generator and nacelle of the wind power installation 100, for example.

According to FIG. 1 and FIG. 2, the open-loop and closed-loop control device 200 receives measurement information from a sensor system 230 via a signal line 231, which information passes to a measurement module 210 of the open-loop and closed-loop control device 200.

This measurement module 210 has a first determination unit 211 for determining a density and a second determination unit 212 for determining the rotational speed n of a rotor of the wind power installation.

A pilot control unit 221—for example a computing unit or the like having one or more stored operating characteristic curves R(n′, n*)—is also provided as part of the closed-loop controllers 220 and is able to specify an adapted rotational speed n′ according to a density-adapted operating characteristic curve R(n′) and/or a rotational speed n* which is corrected further; in the present case, also an operating characteristic curve R(n*) corresponding to a calculated sound pressure S.

The rotational speed n′, n* adapted and/or corrected in this manner—that is to say a rotational speed n′ which is adapted according to the pilot control unit 221 and is additionally or alternatively (preferably additionally) corrected according to a sound pressure S and/or a density-adapted power P to form a rotational speed n*—can be passed to the wind power installation 100 and to the corresponding actuating device 300 of the latter via a further signal line 232. As a result, the rotational speed n* can be adapted further in such a manner that the power is optimized taking into account the density-adapted power and the sound pressure S.

As mentioned at the outset, power calculations for a wind power installation are currently carried out assuming the standard atmosphere. The standard density ρ_norm used in this case for the air density ρ_Luft is ρ_norm=1.225 kg/m³. At sites of high altitude and/or with temperatures increased on average, this assumption is no longer quantitatively correct, however, and deviations in the density toward smaller values of up to approximately 20% of the design conditions based on the standard density ρ_norm used may perfectly well arise.

In contrast with the prior art, provided is a corresponding specific power of the wind power installation that is provided even for a lower density; that is to say for a wind speed which is otherwise the same and a rotational speed which is also initially the same—however, the lower density can be compensated for by means of an increased rotational speed. The wind power installation is then operated at a rotational speed greater than the desired rotational speed n_soll. An increased value of an AEP (annual energy production) can also be ultimately expected as a result of the higher rotational speed. A wind power installation is therefore designed according to a predetermined temperature envelope in accordance with the IEC (International Engineering Code).

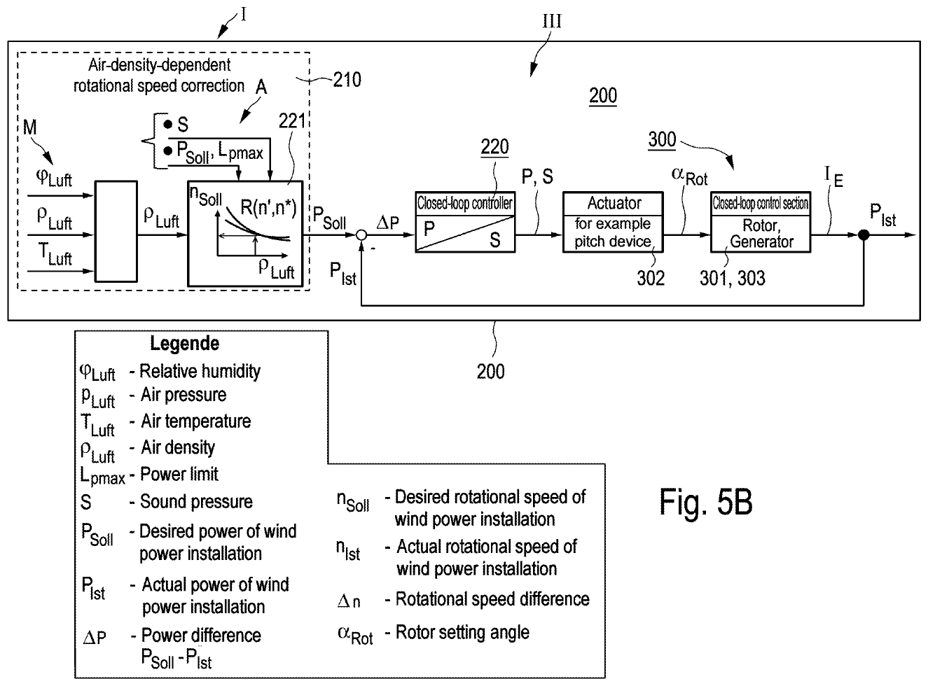

At the same time, it should also be noted that an increase in the rotational speed results in an increased sound emission of the wind power installation. Adapted operational management, as illustrated in FIG. 5A and FIG. 5B, consequently takes into account both factors within the scope of one preferred embodiment: power P and sound pressure S.

On the basis of theoretical estimations, it is possible to adapt the rotational speeds n of the operating characteristic curve R(n), the nominal rotational speed and the desired rotational speed of the wind power installation assuming constant power and optionally a constant or largely identical sound pressure S. For a constant power P, a rotational speed correction—that is to say as identified by the invention according to the first variant—can be carried out according to n′=n_korr using

$${n}_{korr} = {{n}_{norm} ( \frac{{ρ}_{norm}}{ρ} )}^{\frac{1}{3}}$$

In this case, the rotational speed n_norm relates to the rotational speed corresponding to the operating characteristic curve.

If it is assumed that the resulting sound pressure S does not change, the rotational speed can also be corrected—according to the second variant of the invention—according to n*=n_korr using

$${n}_{korr} = {{n}_{norm} ( \frac{{ρ}_{norm}}{ρ} )}^{\frac{2}{5}}$$

In comparison with the first correction, the rotational speed can even be slightly increased with regard to a sound pressure S. This would increase the efficiency of the generator.

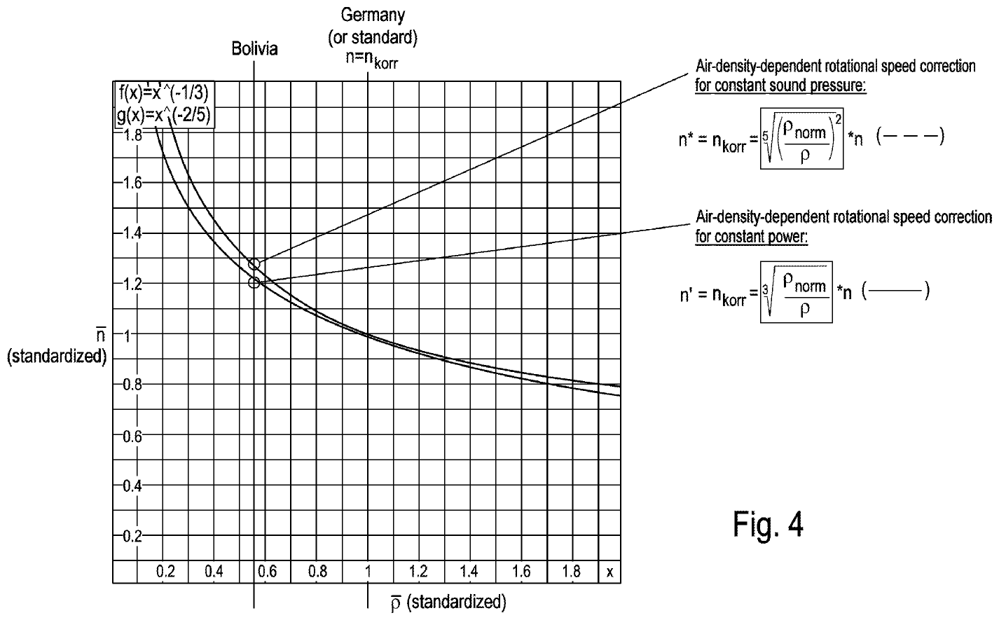

FIG. 3 shows, in this respect, a contour plot K relating to a rotational speed n_quer standardized to the nominal rotational speed n_nenn with respect to a density ρ_quer standardized to the standard density ρ_norm. The standardized density ρ_quer can be seen on the x axis and the standardized rotational speed n_quer can be seen on the y axis, both standardized to reference variables n_nenn and ρ_norm. The contour corresponds to the deviation from the sound pressure S (here, for example, a decisive value for sound pressure levels SPL or sound power levels). In the region of densities less than the reference density (1.225 kg/m³), rotational speeds of n>n_nenn can be used, as can be seen, namely along the 0-dB contour; that is to say the adapted rotational speed is corrected and the installation is operated by means of the corrected rotational speed at a corrected sound emission limit (according to the specifications with respect to the sound pressure S, for example by means of an allocated sound pressure level SPL). In other words, the installation—possibly alone with respect to the sound pressure S or in combination with respect to the power P—would therefore be subjected to closed-loop control, that is to say with respect to the expected sound emission. In this case, the sound power level or sound pressure level SPL is determined approximately, for example by simultaneously capturing the density ρ and rotational speed n. Such closed-loop control makes it possible to achieve an increased AEP (annual energy production) at particular sites with air of a lower density (warmer air and/or high altitude above sea level).

That is to say: in the case of a considerably lower density on account of site-specific parameters (altitude of the site, temperature), the expected sound pressure S falls. A correction is possible and is provided according to the invention for the density by means of the one or more stored adapted operating characteristic curves R(n′, n*).

If the lower density is a consequence of increased temperature, the influence of the temperature T on the speed of sound c₀ will also be additionally taken into account in this particularly preferred embodiment. Since an increased speed of sound results in a lower Mach number, a further slight reduction in the sound pressure level SPL can be expected. The reduced sound pressure S to be expected can be used to adapt the nominal rotational speed. As a result, the sound pressure would increase again. However, under simplified assumptions, it can be estimated that the increase in the sound pressure S on account of the increased rotational speed is lower than the reduction on account of a lower density.

Specifically:
At sites of high altitude—for example Tchamma, Chile—the density is reduced for the same speed of sound. At other sites, there may be a reduced density on account of increased environmental temperatures. In the latter case, the speed of sound c₀ also changes as a function of the temperature

c₀=\sqrt{κRT} (1)

where the isentropic exponent ϰ and the specific gas constant of air, R, are considered to be constant. The density likewise changes with the temperature.

In the case of the turbulent flow around bodies, the generation of sound can be described on the basis of Lighthill's acoustic analogy according to the publication “M. J. Lighthill, “On sound generated aerodynamically. I. General theory.,” Proc. R. Soc. London, vol. 211, no. 1107, pp. 564-587, 1951,” Under the simplified assumption of an incompressible flow, there follows a linear relationship between sound pressure and density.

In accordance with the publication “Ffowcs-Williams Hall in J. E. Ffowcs Williams and L. H. Hall, “Aerodynamic sound generation by turbulent flow in the vicinity of a scattering half plane.,” J Fluid Mech, vol. 40, pp. 657-670, 1970,” the trailing edge noise is linked to the density and the speed of sound via

p′∝ρ₀Ma^{2.5} (2)

In accordance with the publication “Amiet et al. in “J sound Vib.” vol. 41 no. 4 pp. 407-420 (1975),” a similar proportionality can be expected.

It is consequently proposed that the sound pressure (SPL—sound pressure level) is calculated using a simple scaling law in the event of a change in the density, which is confirmed by means of measurements of the influence of the density ρ on the turbulent noise (with suction and pressure side components and with contributions induced by detachment):

$$SPL ( {ρ}_{n} ) = SPL ( {ρ}_{ref} ) + 20 * {log}_{10} ( \frac{{ρ}_{n}}{{ρ}_{norm}} ) \qquad ( 3 )$$

Similar scaling also applies to a differing speed of sound or Mach number, which could likewise be verified using the influence of a changed speed of sound c₀ on different noise mechanisms:

$$SPL ( {c}_{n} ) = SPL ( {c}_{ref} ) + 20 * {log}_{10} ( {( \frac{{c}_{norm}}{{c}_{n}} )}^{2.5} ) \qquad ( 4 )$$

In this case, a subscript n relates to the adapted environmental variables and ref relates to the variables according to the standard atmosphere.

On the one hand, the following applies to the wind power:

$$p = \frac{ρ}{2} {v}_{∞}^{3} {Ac}_{p} η = \frac{ρ}{2} \frac{{v}_{tip}^{3}}{{λ}^{3}} {Ac}_{p} η \qquad ( 5 )$$

In this case, A represents the area through which there is a flow, η represents the generator efficiency and cₚ represents the coefficient of power. The coefficient of power is assumed to be constant below. If the power is kept constant, the following results for the blade tip speed vₜᵢₚ

$${v}_{tip} = \sqrt[3]{\frac{2 P {λ}^{3}}{ρ {Ac}_{p} η}} ∼ \sqrt[3]{\frac{1}{ρ}} \qquad ( 6 )$$

The power therefore falls linearly with the air density.

On the other hand, assuming a constant speed of sound c₀, the following applies to the Mach number

Ma˜vₜᵢₚ˜ρ^{1/3} (7)

using relationship (6). The sound pressure S (p′ in the formula) is scaled with the density and Mach number as follows:

p′˜ρMa^{2.5} (8)

If relationship (7) is now inserted into (8), the following results for the sound pressure S (p′ in the formula) for an adapted rotational speed

p′˜ρ^{1/6} (9)

With the same installation power, an adapted rotational speed and a lower density, the sound pressure S should therefore be smaller than under standard conditions.

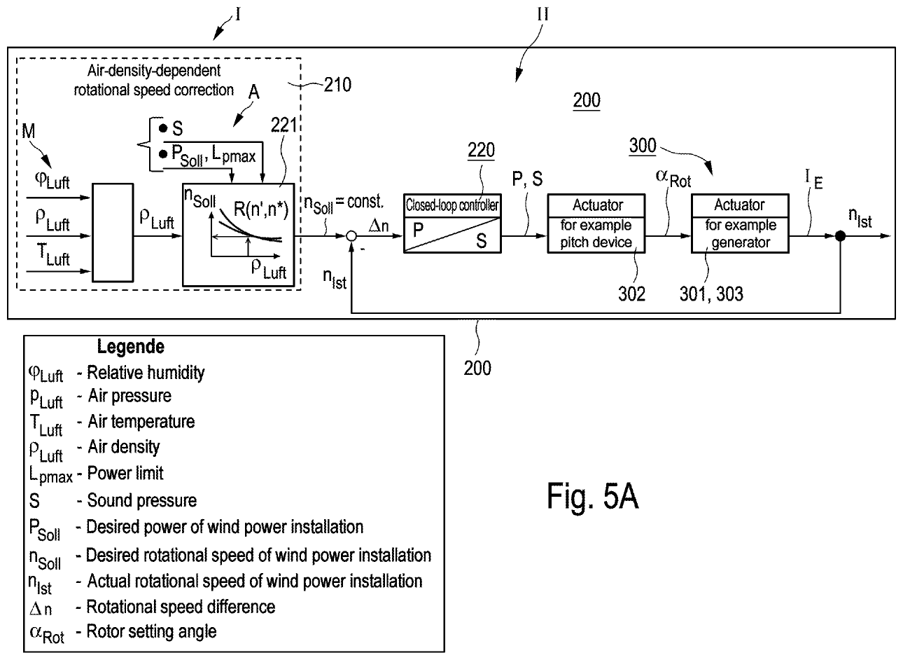

As illustrated in FIG. 4, the following therefore applies on the one hand: for the same power, there is an increased inflow speed for a reduced air density ρ. The rotational speeds in the operating characteristic curve and the desired rotational speed can then be adapted according to the following relationship in order to keep the tip speed ratio constant using the rotational speed:

$${n}_{korr} = \sqrt[3]{\frac{{ρ}_{norm}}{ρ}} n \qquad ( 10 )$$

(corresponds to formula I; in particular n_korr=n)

In this case, ρₙₒᵣₘ is the standard density for which the operating characteristic curve was originally designed and n_{_korr} is the corrected rotational speed n′ in comparison with the rotational speed n originally defined in the operating characteristic curve.

Additionally or alternatively, it is also possible to adapt the rotational speed in such a manner that the sound pressure S (p′ in the formula) remains constant. According to equation (8), the sound pressure (p′ in the formula) is dependent on the density and Mach speed or blade tip speed.

$${p}^{′} = const . ∼ \frac{ρ}{{ρ}_{norm}} {( \frac{{v}_{tip}}{{v}_{tip} , norm} )}^{2.5} \qquad ( 11 )$$

It follows from this that, for the same sound pressure S, the rotational speed can change according to the density, as likewise illustrated in FIG. 4, using

$${n}_{korr} = {( \frac{{ρ}_{norm}}{ρ} )}^{\frac{2}{5}} n \qquad ( 12 )$$

(corresponds to formula II, in particular n_korr=n*)

According to equation (12), even a slightly higher rotational speed n* in comparison with equation (10) could therefore be used.

FIG. 5A contains a method for operating a wind power installation having a rotor and a generator driven via the rotor for generating an electrical power according to FIG. 1 or FIG. 2, by way of example within the scope of closed-loop control explained for operation under full load. Full-load operation relates to operation of the wind power installation substantially above the nominal wind speed. The nominal power can usually be reached when the wind speed has reached the nominal wind speed. For the method, modified pilot control I is implemented in a first step by means of a measurement module 210. Within the scope of this pilot control I, an environmental variable M relevant to the wind power installation and comprising at least an air density relative to the wind power installation is determined. In the present case, in the modified pilot control as part of the measurement module 210 in the embodiment in FIG. 5A, the density ρ_Luft is first of all determined by simultaneously measuring the air pressure p_Luft, the temperature T_Luft and possibly the relative humidity φ_Luft. The captured value is used directly for the pilot control and/or closed-loop control of the installation rotational speed n, specifically using the pilot control unit 221 illustrated in FIG. 5A—for example using a computing unit or the like with stored operating characteristic curves R(n′, n*). In order to suppress high-frequency fluctuation of the measured values, the measured values are filtered using a sliding average or the like (not illustrated). The installation open-loop control is also accordingly adapted. A rotational speed n of the rotor as n_IST and an electrical power P_SOLL to be output and a sound pressure S and possibly a power limit Lp_max of the generator are specified as installation values A.

The wind power installation, in particular the generator, namely here an excitation current of the generator, is specified for the purpose of generating the power to be output according to operational management which indicates a relationship between the rotational speed of the rotor and the electrical power to be output—in this case, this comprises the operating characteristic curve R(n′, n*) or the contour K described in FIG. 3 as part of pilot control I which is assigned to the measurement module 210. In this case, the operational management is adapted on the basis of the air density ρ_Luft relevant to the wind power installation.

The purpose of a subsequent closed-loop control circuit II in the full-load range for carrying out the method according to the embodiment in FIG. 5A or of a subsequent closed-loop control circuit III in the partial-load range for carrying out the method according to the embodiment in FIG. 5B is then automatic adaptation of the operational management taking into account the corrected rotational speed n→n_korr=n′ or n_korr=n* on the basis of the available air density ρ_Luft. Optimum aerodynamic inflow conditions on the rotor can preferably also be achieved, inter alia, by including the current air density ρ_Luft and ensuring the predicted production while observing the maximum sound emission. As a result, both a summarily power P (starting from the electrical power to be output—P_SOLL during partial-load operation or nominal power during full-load operation) and an upper sound pressure S (for example starting from the specified sound pressure S or possibly a power limit Lp_max of the generator) can be complied with, in particular.

Overall, for a low current air density ρ_Luft, an increased annual energy production AEP can ultimately also be expected using an increased installation rotational speed n→n_korr with n′ or n_korr=n* in comparison with a method of operation which does not take into account a decisive change in the density to lower densities in the case of high installation altitudes of a wind power installation 100 above sea level.

In this case, an adapted rotational speed n′, n* of the rotor of the wind power installation for generating an electrical power to be output is specified using the adapted operational management comprising the adapted operating characteristic curve R(n′, n*) or the contour K described in FIG. 3 from the pilot control I, that is to say using the air density relevant to the wind power installation. In particular, this is used to generate an optimized electrical power P to be output by means of the closed-loop controller 220, wherein the adapted rotational speed n′, n* is regularly a rotational speed n′, n* which is increased in comparison with the normal rotational speed n (for an air density which is assumed to be normal) for a lower air density.

The decisive background is that, in the case of a considerably lower air density ρ on account of site-specific parameters (altitude of the site, level of the temperature), the expected sound pressure S, and therefore the substantially relevant sound emission of the wind power installation, also falls.

For the density ρ, the expected sound emission can be corrected according to the specification of a sound pressure level SPL according to the above formula (3) and this expected sound emission can likewise be included in the operational management, for example as an adapted operating characteristic curve R(n, n*), as in FIG. 5A or FIG. 5B.

If the lower density is a consequence of an increased temperature, the influence of the temperature T on the speed of sound can also be additionally taken into account.

A sound emission of the wind power installation can be (additionally or alternatively) determined for the specified rotational speed n or for the rotational speed n′ of the rotor which has already been adapted with respect to the density by taking into account the operating characteristic curve R(n′, n*), which has been adapted in this respect via the air density ρ and/or the sound pressure S, and/or the contour K described in FIG. 3 using the air density relevant to the wind power installation. Not only a specified rotational speed n can therefore preferably be corrected to form n* but also additionally the rotational speed n′ which has already been adapted with respect to the density can be corrected to form n*—namely on the basis of the using the air density ρ relevant to the wind power installation and the sound pressure S for the determined sound emission S.

Since an increased speed of sound results in a lower Mach number, a further slight reduction in the sound pressure level (SPL) can be expected. The expected sound pressure S which has thus been reduced can be used to adapt the nominal rotational speed n* in the adapted operating characteristic curve R(n′, n*) as well. As a result, the sound pressure would increase again. However, under simplified assumptions, it can be estimated that the increase in the sound pressure S on account of the increased rotational speed n* is lower than the reduction on account of a lower density ρ—pilot control I according to a contour K in FIG. 3 is therefore also appropriate.

This pilot control I by means of the measurement module 210, modified in the sense of the concept of the invention, is followed, for full-load operation, by a closed-loop control section of a closed-loop control circuit II of the device 200 for open-loop and/or closed-loop control (open-loop and closed-loop control device 200) according to FIG. 5A—the operational management has one or more above-mentioned closed-loop controllers 220 for this purpose; as explained, these closed-loop controllers can carry out closed-loop control of the power P (nominal power) adjusted taking into account the rotational speed deviation Δn=n_SOLL−n_IST and with respect to the operating characteristic curve R(n′, n*) adapted in the pilot control I by means of the measuring device 210 and/or the sound pressure S—but preferably, as illustrated, can keep the rotational speed n→n_Soll=n_korr constant or within limits, in particular. The aim of closed-loop control is generally a substantially constant rotational speed during full-load operation and, in any case, a rotational speed within an appropriate bandwidth. The closed-loop control section is fundamentally also configured, with the closed-loop control circuit II, with an actuating device 300 and corresponding actuators 301, 302, 303—the order of the latter is only exemplary here. Like for full-load operation above, this closed-loop control section can carry out closed-loop control of, for example, a blade angle α_Rot of the rotor blades, an excitation current I_E of the generator and/or an azimuth angle of the nacelle or rotor of the wind power installation (not shown)—in particular also for partial-load operation—as is explained in detail on the basis of FIG. 1 and FIG. 2 and for partial-load operation in FIG. 5B, for example.

The result is, in any case for full-load operation, an increased rotational speed n_IST which corresponds to the target value of a density-adapted power P and/or a density-adapted sound pressure S, that is to say the adapted rotational speed n′ and/or corrected rotational speed n*.

FIG. 5B contains a method for operating a wind power installation having a rotor and a generator driven via the rotor for generating an electrical power according to FIG. 1 or FIG. 2, for example within the scope of closed-loop control explained with the closed-loop control circuit III for operation under partial load.

During partial-load operation in which the wind is so weak that the wind power installation 100 cannot yet be operated with its maximum output power, the output power is adjusted on the basis of the wind, that is to say on the basis of the wind speed. Partial-load operation is therefore operation in which the wind power installation cannot yet reach its maximum output power, specifically cannot yet reach its nominal power in particular, on account of wind which is excessively weak. The nominal power can usually be reached when the wind speed has reached the nominal wind speed. Accordingly, partial-load operation also relates to operation of the wind power installation up to the nominal wind speed.

During partial-load operation, the closed-loop controller 220 of the closed-loop control circuit III again receives a power P adjusted taking into account the rotational speed deviation Δn=n_SOLL−n_IST and with respect to the operating characteristic curve R(n′, n*) adapted in the pilot control I by means of the measuring device 210 and/or the adjusted sound pressure S as a specification; in this case, an adapted or corrected rotational speed n′, n* is included according to a reduced density ρ, as explained above.

The wind power installation for generating the power P_Soll to be output can thus be adjusted by adjusting the generator, specifically, in particular, by adjusting an excitation current I_E, preferably of the generator rotor, preferably also by taking into account a specification for the sound pressure S. A blade angle of one or more rotor blades can also be additionally or alternatively adjusted by means of an actuator 302. This can be implemented using a corresponding pitch drive, for example, or using a drive for an actuating angle of one or more flow elements on a rotor blade in the actuator 302. An azimuth position of the nacelle of the wind power installation can also be adjusted by means of an actuator 303.

As a result, an increased rotational speed can also be assumed for partial-load operation and/or an increased rotational speed n_IST can be set for the closed-loop control circuit III—this would then correspond to the target value of a density-adapted power P and/or a density-adapted sound pressure P, that is to say for the adapted rotational speed n′ and/or corrected rotational speed n*. During partial-load operation, the wind power installation is therefore adjusted to generate the power to be output according to the closed-loop control circuit III by adjusting an excitation current I_E of the generator and/or a blade angle α_Rot of a rotor blade and/or an azimuth angle of the nacelle for the purpose of comparing an actual power P_Ist with a desired power P_Soll according to a power difference ΔP, as illustrated in FIG. 5B, for example.

1. A method for operating a wind power installation having a rotor and a generator driven by the rotor for generating an electrical power, the method comprising:
determining an environmental variable relevant to the wind power installation and comprising an air density relevant to the wind power installation,
determining a rotational speed of the rotor,
specifying an electrical power to be output by the generator, and
adjusting the generator by adjusting an excitation current of the generator, for generating the power to be output according to operational management which indicates a relationship between the rotational speed of the rotor and the electrical power to be output,
wherein the operational management is adapted based on the air density relevant to the wind power installation,
wherein an adapted rotational speed of the rotor of the wind power installation is specified using the adapted operational management and therefore using the air density relevant to the wind power installation,
wherein, for generating an optimized electrical power to be output, the adapted rotational speed is an increased rotational speed for a reduced air density, and
wherein at least one of:
a sound emission of the wind power installation is determined for the specified rotational speed or adapted rotational speed of the rotor using the air density relevant to the wind power installation, or
the specified rotational speed or adapted rotational speed is corrected based on the determined sound emission using the air density relevant to the wind power installation.

2. The method as claimed in claim 1, wherein the air density, as a relevant environmental variable, is an air density that is reduced in comparison with a standard density of a standard atmosphere, and wherein the operational management is adapted based on the reduced air density for the wind power installation.

3. The method as claimed in claim 1, wherein:
the corrected rotational speed is further increased in comparison with the adapted rotational speed based on the sound emission determined using the air density relevant to the wind power installation, or
the corrected rotational speed is not increased in comparison with the adapted rotational speed, and wherein the wind power installation is operated with a sound emission that is still lower or remains the same.

4. The method as claimed in claim 1, wherein the adapted rotational speed is limited based on the sound emission determined using the air density relevant to the wind power installation.

5. The method as claimed in claim 1, wherein:
the operational management comprises a rotational speed/power operating characteristic curve;
an adapted operating characteristic curve is specified based on the air density relevant to the wind power installation, and wherein the wind power installation is adjusted based on the adapted rotational speed/power operating characteristic curve in the operational management; and
the specified adapted current rotational speed is specified in the operational management and is then adjusted by open-loop control or closed-loop control.

6. The method as claimed in claim 1, wherein the air density is a current air density at a location of the wind power installation and is continuously measured and dynamically adapted or is measured once and is statically adapted.

7. The method as claimed in claim 1, wherein the air density is determined from measured environmental values, wherein the measured environmental values include an air temperature relevant to the wind power installation.

8. The method as claimed in claim 1, wherein the air density is determined from measured environmental values, wherein the measured environmental values include at least one of: air pressure, relative humidity, or absolute humidity.

9. The method as claimed in claim 1, wherein:
a normal sound emission of the wind power installation in a standard atmosphere is determined for the rotational speed of the rotor,
the normal sound emission is compared with the sound emission of the wind power installation for the adapted rotational speed of the rotor using at least one of: the air density or air temperature relevant to the wind power installation, and
the adapted rotational speed of the rotor of the wind power installation is corrected and is limited based on the sound emission.

10. The method as claimed in claim 1, wherein:
the wind power installation is operated by the corrected rotational speed for the corrected sound emission in such a manner that the wind power installation is operated at a corrected sound emission limit.

11. The method as claimed in claim 1, wherein:
the rotational speed of the rotor is initially adjusted taking into account a predetermined standard density of a standard atmosphere,
the adapted rotational speed is then specified taking into account at least one of: the air density or air temperature relevant to the wind power installation, and
the adapted rotational speed is corrected and the wind power installation is operated using the corrected rotational speed at the corrected sound emission limit.

12. The method as claimed in claim 10, wherein the air density is an air density that is reduced in comparison with a standard density, and wherein the corrected rotational speed is a rotational speed that is increased in comparison with the rotational speed for the standard atmosphere and a rotational speed that is increased or further limited in comparison with the adapted rotational speed.

13. The method as claimed in claim 1, wherein the wind power installation is adjusted by specifying at least one of: the adapted rotational speed or the adapted and corrected rotational speed.

14. The method as claimed in claim 1, wherein, by specifying the electrical power to be output, the air density, and the sound emission, the rotational speed is adjusted by controlling a setting angle of a component on the rotor, in particular a pitch angle of a rotor blade, and/or a setting angle and/or one or more flow elements on a rotor blade.

15. A device for the open-loop and/or closed-loop control of a wind power installation, the device having the operational management configured to carry out the method as claimed claim 1, wherein the operational management comprises a rotational speed/power operating characteristic curve, wherein the adapted operating characteristic curve is set up and specified in the operational management based on the air density relevant to the wind power installation.

16. A wind power installation comprising:
a rotor;
a generator driven by the rotor for generating electrical power;
the device as claimed in claim 15.

17. A wind farm comprising a plurality of wind power installations that, for purposes of feeding in power generated by the plurality of wind power installations, are connected to a supply network at a common feed-in point, and wherein at least one of the plurality of wind power installations is a wind power installation as claimed in claim 16.

18. The method as claimed in claim 13, wherein the wind power installation is adjusted during a full-load operation by the closed-loop control of the rotational speed.

19. The method as claimed in claim 13, wherein the wind power installation is adjusted during partial-load operation, by adjusting at least one of: the generator, by adjusting an excitation current, by adjusting one or more rotor blades or a flow element on a rotor blade of the rotor.

20. The method as claimed in claim 14, wherein the setting angle of the component on the rotor is a pitch angle of a rotor blade.
